(19) United States
(12) Patent Application Publication
(10) Pub. No.: US 2001/0003942 A1
(43) Pub. Date: Jun. 21, 2001

(54) Electronic musical toy instrument

(76) Inventors: Mieko Yabushita, Tokyo (JP); Makoto Takezaki, Tokyo (JP); Katsumi Araki, Tokyo (JP)

Correspondence Address: STAAS & HALSEY LLP, 700 11TH STREET, NW, SUITE 500, WASHINGTON, DC, 20001, US

(21) Appl. No.: 09/771,584

(22) Filed: Jan. 30, 2001

(30) Foreign Application Priority Data
Aug. 24, 1999 (JP) PATENT 11-237577

(51) Int. Cl. G10H 1/26

(52) U.S. Cl. 84/609

(57) ABSTRACT

An electronic musical toy instrument has a first memory unit for storing a lot of music sound data for playing music, a second memory unit for storing sound data that corresponds to a sound responding to the progress of the music, a sound output unit for generating sound that corresponds to the music sound data or the sound data, and an operating member for reading the sound data out of the second memory unit. With the electronic musical toy instrument, a sound that corresponds to the sound data is generated from the sound output unit by an actuation of the operating member.

### BACKGROUND OF THE INVENTION

1. Field of the Invention

The present invention relates to a toy instrument, especially an electronic musical toy instrument capable of generating chord or the like in response to the progress of chord by an artificial operation during a music performance.

2. Description of Related Art

An electronic musical toy instrument is known in the art, which has, for example, a memory unit for storing musical sound data for several pieces of music. When a person selects a music and pushes a keyboard, musical sound data that corresponds to the selected music is read out of the memory unit one by one in order to generate sounds of music one by one from a sound output unit.

This electronic musical toy instrument allows that a piece of music can easily played by pushing repeatedly one keyboard on a continual basis even if it is played by a person who cannot read a score or play the music using a real instrument.

However, on the other hand, there is a problem that a player becomes weary of a simple performance as a lot of musical sound data are read out of the memory unit in order and music can be played apart from a sense of rhythm.

### SUMMARY OF THE INVENTION

The present invention is attained in view of such a problem. An object of the present invention is to provide an electronic musical toy instrument that gives pleasure for a long time.

In accordance with one aspect of the present invention, an electronic musical toy instrument comprises a first memory unit for storing a lot of music sound data for playing music, a second memory unit for storing sound data that corresponds to a sound responding to the progress of the music, a sound output unit for generating sound that corresponds to the music sound data or the sound data, and an operating member for reading the sound data out of the second memory unit. With the electronic musical toy instrument, a sound that corresponds to the sound data is generated from the sound output unit by an actuation of the operating member.

Here, “a sound responding to the progress of music” includes, but not limited to, a sound (a keynote) to be provided as a key of playing music, a chord (including a proxy chord) that corresponds to a melody of the music, or a tone of sound that corresponds to a melody of the music. “A music sound data” means a sound data that corresponds to one of a plurality of sounds that make up music (a single sound or a composite sound of single sounds). The music sound data stored in the first memory unit are, for example, automatically read out for music to be automatically played, or the music sound data are read out and played by actuating another operating member.

According to the electronic musical toy instrument, the operating member allows that the music is arranged to one's liking, so that the performance can be enjoyed by the degree of such an arrangement.

The operating member of the electronic musical toy instrument may have a shape of a rod in imitation of a string of a stringed instrument.

In this case, the operating member may be provided so that it extends in a horizontal direction or it extends in a vertical direction, or furthermore it may extend in a slanting direction. Preferably, a chord in this case may be string sounds of a stringed instrument such as a guitar or a base. Accordingly, an image of just like playing a stringed instrument such as a guitar or a base can be produced.

The electronic music toy instrument may have two or more operating members, and generate different tone of sound per an octave by the selection of the operating members, resulting in the changes in a music performance.

The electronic music toy instrument may have a percussion instrument. Sound data of the percussion instrument may be stored in a third memory unit. The sound data may be read out of the third memory unit at the time of beating the percussion instrument to generate the percussion sound that corresponds to the percussion sound data from the sound output unit. In this case, the percussion sound may be only generated during the period of playing the music or also generated during the period of without playing the music. The percussion instruments of this case may include not only percussion instruments in the narrow sense such as a “taiko”, a cymbals, and a drum, but also include any of means such as a clapping of hands to produce a sound of beating hands together and furthermore any of means that produce sounds by beating such as a kettle or a pan.

According to the electronic musical toy instrument, it becomes more enjoyable electronic musical toy instrument because of generating of percussion sound (a single sound or sequence sounds) by beating the percussion instrument.

The electronic musical toy instrument may have a scratch dial. Scratch sound data may be stored in a fourth memory unit to read the scratch sound data out of the fourth memory unit at the time of operating the scratch dial. Then, a scratch sound that corresponds to the scratch sound data may be generated from the sound output unit. In this case, the scratch sound may be only generated during the period of playing the music or also generated during the period of without playing the music.

According to the electronic musical toy instrument, a scratch sound can be generated by operating the scratch dial, so that a more enjoyable electronic musical toy instrument can be realized.

### BRIEF DESCRIPTION OF THE DRAWINGS

The above and other objects, features and advantages of the invention will become more apparent from the following description taken in conjunction with the accompanying drawings wherein like references refer to like parts and wherein:

FIG. 1 is a perspective view of an electronic musical toy instrument according to the present invention;

FIG. 2 is a circuit diagram of the electronic musical toy instrument of FIG. 1;

FIG. 3 is a cross sectional view of a percussion instrument of the electronic musical toy instrument of FIG. 1;

FIG. 4 is a cross sectional view of a body of the electronic musical toy instrument of FIG. 1 from the underside;

FIG. 5 is a perspective view of a ball axis of the electronic musical toy instrument of FIG. 1 and a neighboring portion of the ball axis from the underside;

FIG. 6 is a cross sectional view of a ball and strings of the electronic musical toy instrument of FIG. 1;

FIG. 7 is an exploded perspective view of the strings and the like of the electronic musical toy instrument of FIG. 1 from the underside; and

FIG. 8 is a cross sectional view of a scratch drum and its neighboring portion of the electronic musical toy instrument of FIG. 1.

### PREFERRED EMBODIMENT OF THE INVENTION

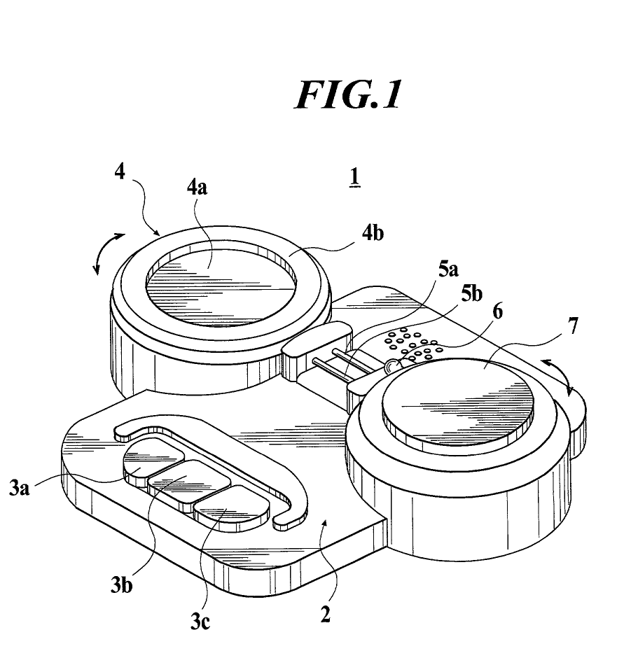

FIG. 1 shows an electronic musical toy instrument in accordance with the embodiment of the present invention. First, the way of playing the electronic musical toy instrument 1 will be described in addition to describe its action for the purpose of briefly understanding the total configuration of the electronic musical toy instrument 1.

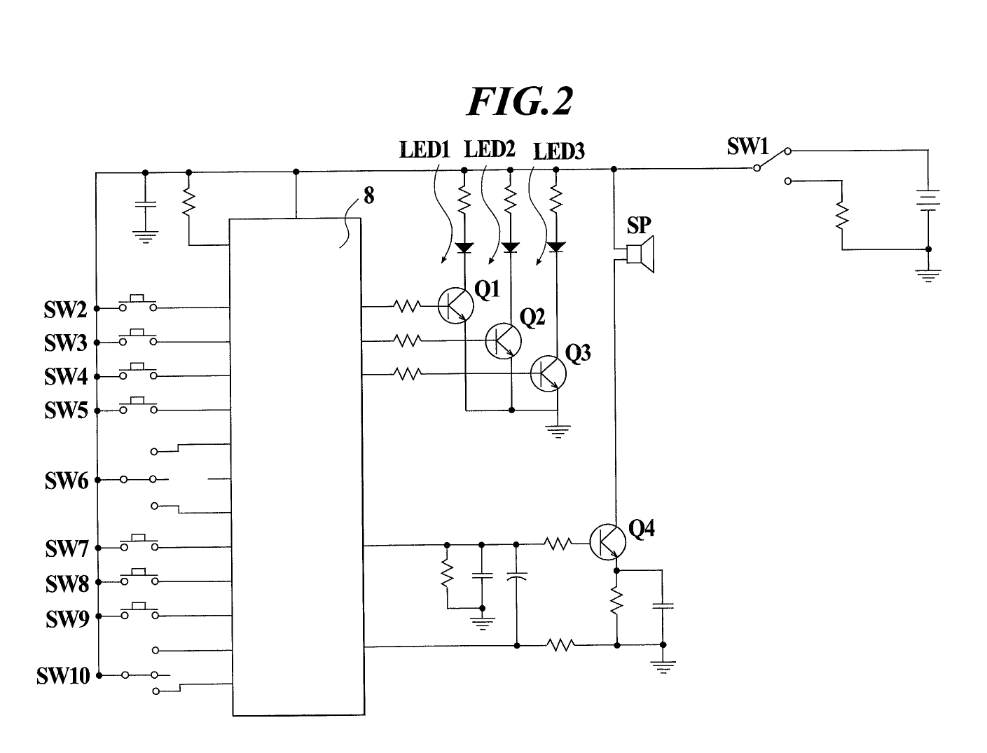

A switch SW1 (see FIG. 2) on the backside of the body 2 can be switched between “OFF” and “ON”. If the switch SW1 is flipped to “ON” and one of three milky-white-colored keys 3a, 3b and 3c which are modeled on a keyboard is pushed, music that corresponds to the pushed key is automatically played. During the automatic play, the key that corresponds to the automatically played music shines red in accordance with a melody.

During the period of playing the music, in addition, a percussion sound is generated by beating a beating portion 4a of a percussion instrument 4. For the percussion sounds, “a drum sound”, “a cymbals sound”, and “a handclap sound” are prepared. The switching of these sounds is performed by turning a frame body 4b of the beating portion 4a right and left.

Furthermore, if one of string-like rods (hereinafter, referred to as “strings”) 5a and 5b is played during the period of playing the music, a sound including a chord that corresponds to or suitable for the progress of the music being played is produced as a sound of stringed instrument. Regarding the difference between the strings 5a and 5b, for example, the string 5a positioned on the far side is responsible for a low tone or note and the string 5b positioned on this side is responsible for a high tone or note. If the progress of the music is performed using C code of chord, the low tone is defined as C3 and the high tone is defined as C4.

During the period of playing the music, also, a funny sound such as “pyo-o-o” is produced when a ball 6 is pulled upward, and another sound such as “pon” is produced when the ball 6 is returned to its original position.

Furthermore, during the period of playing the music, an output of scratch sound is produced by turning the scratch dial 7 right and left. In this case, the same scratch sounds may be obtained in both right and left directions. We can also get more pleasure from the different scratch sounds depending on the right and left directions, respectively.

If the percussion instrument 4, the strings 5a and 5b, the ball 6, and the scratch dial 7 are operated simultaneously and continuously, the sounds that correspond to all operated instruments may be generated, or alternatively the sounds may be assigned their own priorities and played in order of the priorities. Alternatively, the number of the operations performed on each of the instruments may be counted so that only a predetermined number of the operations will become effective to generate sound depending the effective operations.

Next, a circuit configuration of the inner workings of the electronic musical toy instrument 1 will be described. The electronic musical toy instrument 1 has ten switches SW1 to SW10 as shown in FIG. 2. The switch SW1 is a power switch as described above. The switches SW2, SW3 and SW4 are music-selection switches that respond to keys 3a, 3b and 3c, respectively. The switch SW5 is a beating-detection switch that respond to the percussion instrument 4. The switch SW6 is a switch for selecting sounds of the percussion instrument. The switches SW7 and SW8 are press-detection switches that respond to the strings 5a and 5b, respectively. The switch SW9 is a tension-detection switch that responds to the ball 6. The switch SW10 is a switch for detecting an operation of the scratch dial 7.

These switches SW1 to SW10 are connected to the input side of a microprocessor 8. The microprocessor 8 comprises a memory unit, where music sound data, percussion sound data, chord data, funny sound data, and scratch sound data are stored. On the other hand, red LED1, LED2 and LED3 and a speaker SP as a sound output unit are connected to the output side of the microprocessor 8 via an amplification portion having transistors Q1 to Q4, respectively. In this case, the transistors Q1, Q2 and Q3 and the LED1, LED2 and LED3 respond to the switches SW2, SW3 and SW4, respectively. If the switches SW2 to SW4 are flipped to “ON”, the corresponding music sound data are read out of the memory unit. Then, the corresponding transistors are actuated to generate the corresponding music from the speaker SP, making the red LEDs emit in accordance with melodies of the music. The LEDs are incorporated in the keys 3a, 3b and 3c, respectively. The transistor Q4 responds to the switches SW5 and SW7 to SW10. If the switches SW5 and SW7 to SW10 are flipped to “On”, the corresponding transistors are actuated to generate the corresponding sound from the speaker SP.

In this embodiment, the switch SW1 may be, for example, a sliding switch to be operated by a slidable knob. The switches SW2 to SW4 may be, for example, a push-button switches to be operated by pushing the keys 3a, 3b and 3c, respectively.

Regarding a mechanical configuration of the switch SW5, the switch SW5 may be constructed so that the switch SW5 is flipped to “ON” whenever any portion of the beating portion 4a is beaten.

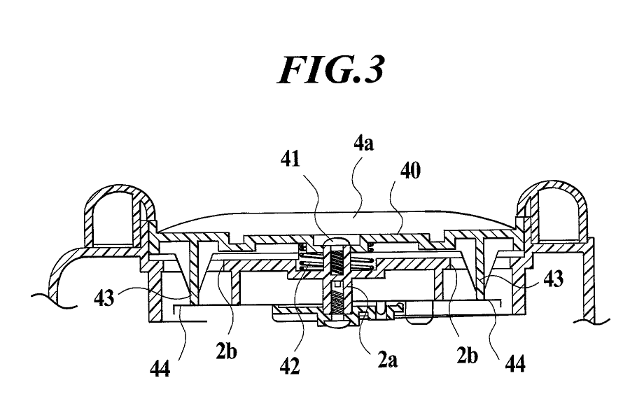

That is, as shown in FIG. 3, an axial portion 2a formed in the body 2 loosely passes through a central hole of a holder 40. The holder 40 is fixed on the axial portion 2a by screws 41 having washers so that the holder 40 is not detached from the axial portion 2a. In addition, the holder 40 is pushed upward by a spring tension of a compression spring 42 being wound around the axial portion 2a. Therefore, if the beating portion 4a attached on the holder 40 is beaten, the holder 40 moves downward along the axial portion 2a or swings around the axial portion 2a.

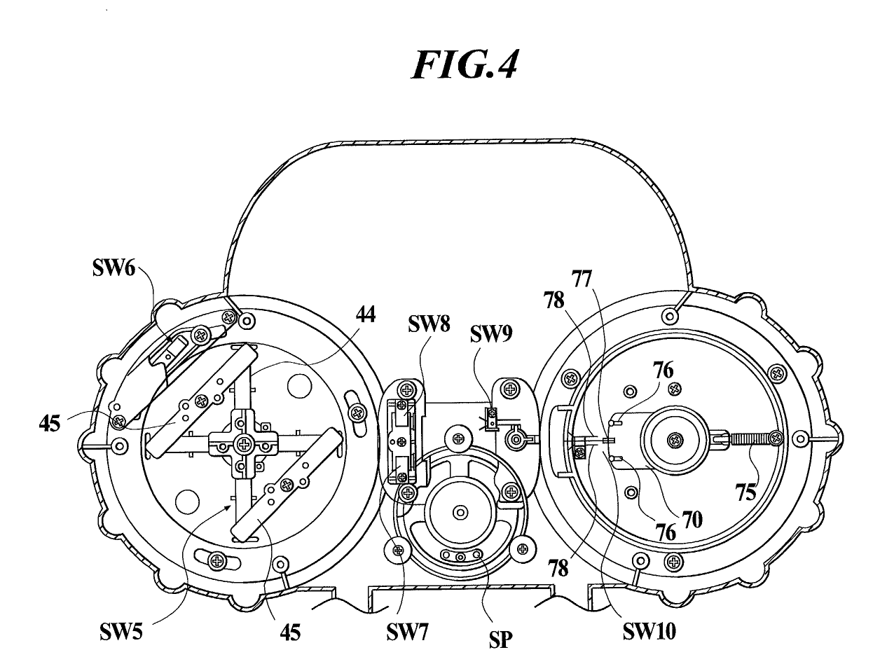

Protruding members 43 are disposed on four portions of the bottom surface of the holder 40. These four protruding members 43 extend to the inside of the body 2 through four openings 2b formed on an upper wall of the body 2, respectively. Lower ends of the four protruding members 43 are in contact with tip portions of a contact plate 44 of the same pole in the shape of a cross being disposed on the axial portion 2a (see FIG. 4). Two contact plates 45 of the same pole are disposed under the contact plate 44 and fixed on the side of the body 2. Both ends of each contact plate 45 are positioned below the tip portions of the adjacent contact plates 44 and 44 in the shape of a cross.

As a result, the contact plate 44 and the contact plate 45 come into contact with each other whenever any portion of the beating portion 4a is beaten, flipping the switch SW5 to “ON”.

Furthermore, the switch SW6 is provided as a sliding switch to be operated, for example, at the time of turning the frame body 4b.

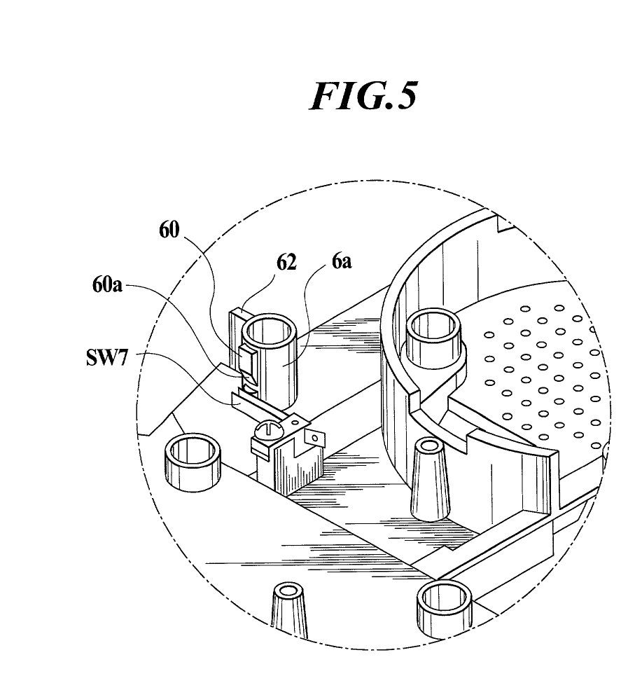

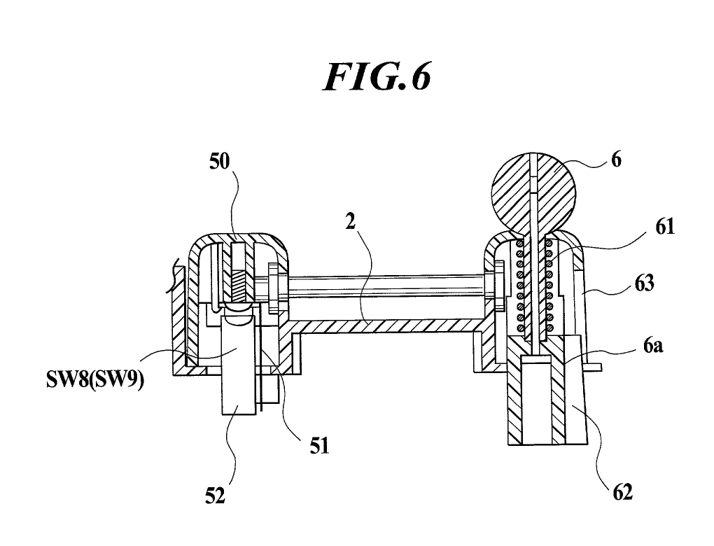

Regarding a mechanical configuration of the switch SW7, the switch SW7 may be a leaf switch that is actuated by a projection 60 provided on the periphery of an axial portion 6a of the ball 6 as shown in FIG. 5 (a perspective view of the backside). In this case, as shown in FIG. 6, the ball 6 is pushed downward by a spring tension of a compression spring 61 being wound around the axial portion 6a. In addition, another projection 62 is formed on the axial portion 6a. The projection 62 faces onto a guide slit 63 formed on the side of the body 2. Therefore, the projection 62 and also the ball 6 move up and down along the guide slit 63. An inclined surface 60a on the upper end of the projection 60 permits that one of the contact plates of the switch SW7 comes into contact with the other contact plate when the projection 62 moves upward.

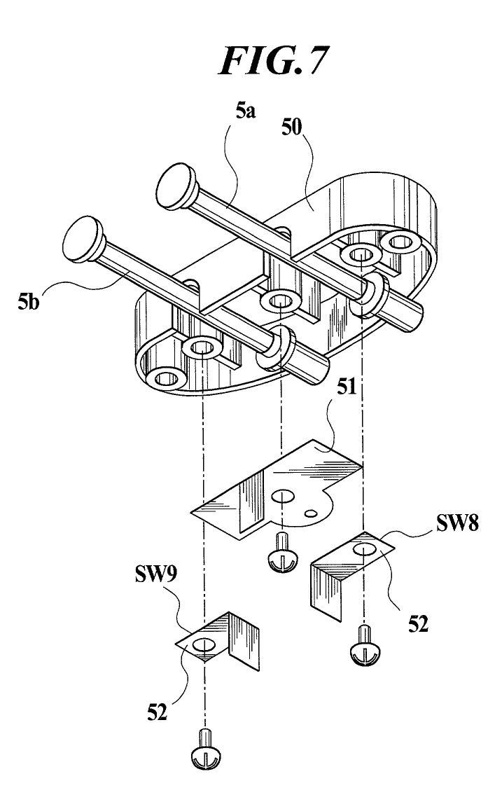

The switches SW8 and SW9 are provided so as to be corresponded to the strings 5a and 5b, respectively. These switches SW8 and SW9 are disposed in the inside of a cover 50 as shown in FIG. 6 (a partial cross sectional view) and FIG. 7 (a perspective view of the backside). In the cover 50, one end portion of each of the strings 5a and 5b is disposed. The switches SW8 and SW9 have a common contact plate 51. The common contact plate 51 is fixed on the cover 50 by means of a screw so as to hold one end portion of each of the strings 5a and 5b. In addition, individual contact plates 52 and 52 of the switches SW8 and SW9 are fixed on the cover 50 by means of screws toward a lower place with respect to the common contact plate 51 so as to keep the individual contact plates 52 and 52 from contact with the common contact plate 51. Then, the side of the cover 50 of each strings 5a and 5b is arranged so that it slightly moves downward against tension of the common contact plate 51. When the strings 5a and 5b are pressed, the common contact plate 51 can be deformed by the strings 5a and 5b, so that the common contact plate 51 is brought into contact with the individual contact plates 52.

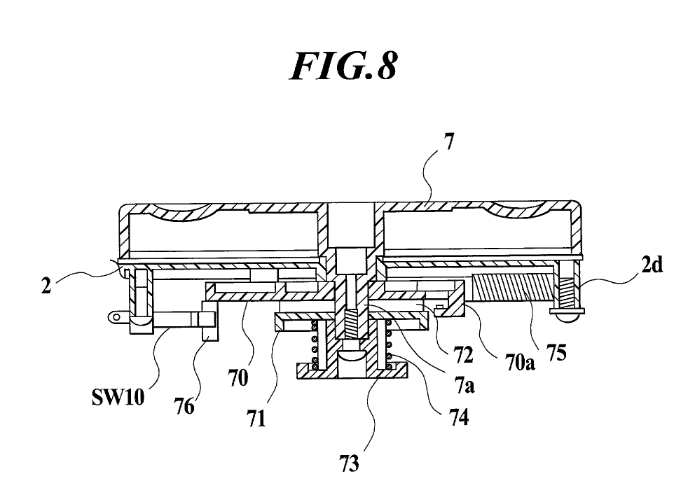

The switch SW10 is provided so as to correspond to the scratch dial 7. As shown in FIG. 8 (a partial cross sectional view), an axial portion 7a of the scratch dial 7 extends to the inside of the body 2 through the upper wall of the body 2. A lever 70 and a clutch plate 71 are attached to the axial portion 7a. A clutch disk 72 is sandwiched between them so that they are able to release and turn free with respect to each other. In addition, a holder 73 is securely installed on the lower end of the axial portion 7a. A compression spring 74 wound around the axial portion 7a is positioned between the holder 73 and the clutch plate 71. Then, the scratch dial 7 and the lever 70 are integrally moved together by means of spring tension of the compression spring 74. As also shown in FIG. 4, an extension spring 75 is hooked between a spring-hooking portion 70a of the lever 70 and a spring-hooking portion 2d of the body 2. The spring-hooking portion 2d is under the upper wall. The extension spring 75 restricts a rotating range of the lever 70. On the other hand, as shown in FIG. 4, contact plates 76 and 76 are disposed on the tip portion of the lever 70. These contact plates 76 and 76 are provided on a position at which they are brought into contact with a movable contact plate 77 of the switch SW10 by a rotation of the lever 70. Fixing contact plates 78 and 78 of the switch SW10 are provided on a position at which they sandwiches the movable contact plate 77, so that one of the contact plates 76 and 76 is pressed toward the movable contact plate 77 for the fixing contact plates 78 to come into contact with the movable contact plate 77.

According to the electronic musical toy instrument 1 as described above, various sounds can be produced through manual operation. Accordingly, the operating member allows that the music is arranged to one's liking, so that the performance can be enjoyed by the degree of such an arrangement.

The embodiment of the present invention has been described above, however, the present invention is not limited to such an embodiment. Various modifications can be applied without departing from the scope of the present invention.

In the above-described embodiment, for example, a chord is produced by a sound of the percussion instrument by operating the strings. However, a chord may be produced by a piano sound by operating the keys.

Furthermore, the above description does not refer to the kinds of percussion sounds and scratch sounds. However, a percussion sound or a scratch sound or both sounds may be modified to be in harmony with music.

What is claimed is:

1. An electronic musical toy instrument comprising:
a first memory unit for storing a lot of music sound data for playing music;
a second memory unit for storing sound data that corresponds to a sound responding to the progress of the music;
a sound output unit for generating sound that corresponds to the music sound data or the sound data; and
an operating member for reading the sound data out of the second memory unit,
wherein a sound that corresponds to the sound data is generated from the sound output unit by an actuation of the operating member.

2. An electronic musical toy instrument comprising:
a first memory unit for storing a lot of music sound data for playing music;
a second memory unit for storing sound data of chord that corresponds to a melody of the music;
a sound output unit for generating sound that corresponds to the music sound data or the sound data; and
an operating member for reading the sound data out of the second memory unit,
wherein a chord responding to the melody of the music is generated from the sound output unit by an actuation of the operating member.

3. The electronic musical toy instrument as claimed in claim 1, wherein the operating member has a shape of a rod in imitation of a string of a stringed instrument.

4. The electronic musical toy instrument as claimed in claim 2, wherein the operating member has a shape of a rod in imitation of a string of a stringed instrument.

5. The electronic musical toy instrument as claimed in claim 1, wherein two or more operating members are provided to produce different tones of sound per an octave when the operating members are actuated, respectively.

6. The electronic musical toy instrument as claimed in claim 2, wherein two or more operating members are provided to produce different tones of sound per an octave when the operating members are actuated, respectively.

7. The electronic musical toy instrument as claimed in claim 1, further comprising a percussion instrument, wherein sound data of the percussion instrument is stored in a third memory unit, and the sound data of the percussion instrument is read out of the third memory unit at the time of beating the percussion instrument to generate the percussion sound that corresponds to the percussion sound data from the sound output unit.

8. The electronic musical toy instrument as claimed in claim 2, further comprising a percussion instrument, wherein sound data of the percussion instrument is stored in a third memory unit, and the sound data of the percussion instrument is read out of the third memory unit at the time of beating the percussion instrument to generate the percussion sound that corresponds to the percussion sound data from the sound output unit.

9. The electronic musical toy instrument as claimed in claim 1, further comprising a scratch dial, wherein scratch sound data is stored in a fourth memory unit, and the scratch sound data is read out of the fourth memory unit at the time of operating the scratch dial to generate the scratch sound that corresponds to the scratch sound data from the sound output unit.

10. The electronic musical toy instrument as claimed in claim 2, further comprising a scratch dial, wherein scratch sound data is stored in a fourth memory unit, and the scratch sound data is read out of the fourth memory unit at the time of operating the scratch dial to generate the scratch sound that corresponds to the scratch sound data from the sound output unit.

11. The electronic musical toy instrument as claimed in claim 1, wherein the music sound data is automatically read out of the first memory unit.

12. The electronic musical toy instrument as claimed in claim 2, wherein the music sound data is automatically read out of the first memory unit.
